(19) United States
(12) Patent Application Publication
(10) Pub. No.: US 2024/0364941 A1
(43) Pub. Date: Oct. 31, 2024

(54) LIVE BROADCAST PROCESSING METHOD, ELECTRONIC DEVICE AND STORAGE MEDIUM

(71) Applicant: Beijing Youzhuju Network Technology Co., Ltd., Beijing (CN)

(72) Inventor: Bowen LIU, Beijing (CN)

(21) Appl. No.: 18/766,518

(22) Filed: Jul. 8, 2024

Related U.S. Application Data
(63) Continuation of application No. PCT/CN2023/071283, filed on Jan. 9, 2023.

(30) Foreign Application Priority Data
Jan. 7, 2022 (CN) 202210016616.2

(51) Int. Cl. H04N 21/2187; H04N 21/466

(52) U.S. Cl. CPC H04N 21/2187; H04N 21/4667

(57) ABSTRACT

A live streaming processing method, a live streaming processing apparatus, an electronic device and a computer-readable storage medium. The live streaming processing method includes: in response to a processing request for a target live streaming room, acquiring information of the target live streaming room and information of an associated live streaming room associated with the target live streaming room; determining a processing result based on the information of the target live streaming room and the information of the associated live streaming room; and displaying the processing result on an information display page.

This application is a continuation of International Patent Application No. PCT/CN2023/071283, filed on Jan. 9, 2023, which claims the priority to and benefits of the Chinee Patent Application, No. 202210016616.2, which was filed on Jan. 7, 2022. All the aforementioned patent applications are hereby incorporated by reference in their entireties.

### TECHNICAL FIELD

Embodiments of the present disclosure relate to a live streaming processing method, a live streaming processing apparatus, an electronic device and a computer-readable storage medium.

### BACKGROUND

With the development of network and computer technology, media formats are more diversified. The media formats arisen in recent years, such as network live streaming, short videos, etc., have been integrated into people's lives increasingly. For network live streaming, in some scenes, the live streaming situation of a live streaming room needs to be timely and accurately known so as to make corresponding adjustment.

### SUMMARY

In the prior art, there is no technical solution capable of timely, accurately and conveniently determining a current situation of a live streaming room, resulting in that user demands cannot be satisfied. With regard to the problem above, at least one embodiment of the present disclosure provides a live streaming processing method, a live streaming processing apparatus, an electronic device, a computer-readable storage medium, and a computer program product. A processing result is determined and shown based on information of the target live streaming room and information of the associated live streaming room, so that the situation of live streaming can be timely and accurately acquired without complex operations, thereby promoting the user experience. At least one embodiment of the present disclosure provides a live streaming processing method, including: in response to a processing request for a target live streaming room, acquiring information of the target live streaming room and information of an associated live streaming room associated with the target live streaming room; determining a processing result based on the information of the target live streaming room and the information of the associated live streaming room; and displaying the processing result on an information display page.

At least one embodiment of the present disclosure further provides a live streaming processing apparatus, including an acquiring unit, a processing unit and a displaying unit. The acquiring unit is configured to, in response to a processing request for a target live streaming room, acquire information of the target live streaming room and information of an associated live streaming room associated with the target live streaming room. The processing unit is configured to determine a processing result based on the information of the target live streaming room and the information of the associated live streaming room. The displaying unit is configured to display the processing result on an information display page.

At least one embodiment of the present disclosure further provides an electronic device, including a processor and a memory, the memory includes one or more computer program modules, the one or more computer program modules are stored in the memory and configured to be executed by the processor, and the one or more computer program modules include instructions for implementing the live streaming processing method according to any one embodiment of the present disclosure.

At least one embodiment of the present disclosure further provides a computer-readable storage medium for storing non-transitory computer-readable instructions, the non-transitory computer-readable instructions, when executed by a computer, implement the live streaming processing method according to any one embodiment of the present disclosure.

At least one embodiment of the present disclosure further provides a computer program product including a computer program carried on a non-transitory computer-readable medium, the computer program includes program codes for executing the live streaming processing method according to any one embodiment of the present disclosure.

### BRIEF DESCRIPTION OF THE DRAWINGS

The above-described and other features, advantages and aspects of the respective embodiments of the present disclosure will become more apparent when taken in conjunction with the accompanying drawings and with reference to the detailed description below. Throughout the drawings, same or similar reference signs refer to same or similar elements. It should be understood that, the drawings are schematic and that originals and elements are not necessarily drawn to scale.

FIG. 1 is a flow schematic diagram of a live streaming processing method provided by some embodiments of the present disclosure;

FIG. 2 is a schematic diagram of an information display page provided by some embodiments of the present disclosure;

FIG. 3 is a schematic diagram of another information display page provided by some embodiments of the present disclosure;

FIG. 4 is a schematic diagram of a partial region of an information display page provided by some embodiments of the present disclosure;

FIG. 5 is a schematic diagram of another information display page provided by some embodiments of the present disclosure;

FIG. 6 is a system which may be used for implementing a live streaming processing method provided by the embodiments of the present disclosure;

FIG. 7 is a schematic block diagram of a live streaming processing apparatus provided by some embodiments of the present disclosure;

FIG. 8 is a schematic block diagram of an electronic device provided by some embodiments of the present disclosure;

FIG. 9 is a schematic block diagram of another electronic device provided by some embodiments of the present disclosure; and

FIG. 10 is a schematic diagram of a computer-readable storage medium provided by some embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as limited to the embodiments set forth here. On the contrary, these embodiments are provided for a more thorough and complete understanding of the present disclosure. It should be understood that the drawings and embodiments of the disclosure are only for illustrative purposes, and are not intended to limit the protection scope of the disclosure.

It should be understood that the steps described in the method embodiments of the present disclosure may be performed in different order and/or in parallel. In addition, the method embodiments may include additional steps and/or omit the steps shown. The scope of the present disclosure is not limited in this respect.

As used herein, the term “including” and its variations are open including, that is, “including but not limited to”. The term “based on” means “at least partially based on”. The term “one embodiment” means “at least one embodiment”; the term “another embodiment” means “at least one other embodiment”; the term “some embodiments” means “at least some embodiments”. Relevant definitions of other terms will be given in the following description.

It should be noted that the concepts of “first” and “second” mentioned in the disclosure are only used to distinguish devices, modules or units, and are not used to limit that these devices, modules or units must be different devices, modules or units, nor to limit the order or interdependence of the functions performed by these devices, modules or units.

It should be noted that the modification “one” and “a plurality” mentioned in this disclosure are illustrative rather than restrictive, and those skilled in the art should understand that unless the context clearly indicates otherwise, they should be understood as “one or more”. “a plurality” should be understood to mean two or more.

The names of interactive messages or information between a plurality of devices in the embodiment of the present disclosure are for illustrative purposes only and should not restrict the scope of the messages or information.

At least one embodiment of the present disclosure provides a live streaming processing method, a live streaming processing apparatus, an electronic device, a computer-readable storage medium, and a computer program product. The situation of a live streaming room can be conveniently and rapidly acquired without frequently switching to other live streaming rooms to perform data comparison, so that time is saved, the operation is simplified, and the user experience is promoted.

Embodiments of the present disclosure will be illustrated in detail below with reference to the drawings.

At least one embodiment of the present disclosure provides a live streaming processing method. The live streaming processing method includes: in response to a processing request for a target live streaming room, acquiring information of the target live streaming room and information of an associated live streaming room associated with the target live streaming room; in response to a checking request for a processing result, determining the processing result based on the information of the target live streaming room and the information of the associated live streaming room; and displaying the processing result on an information display page.

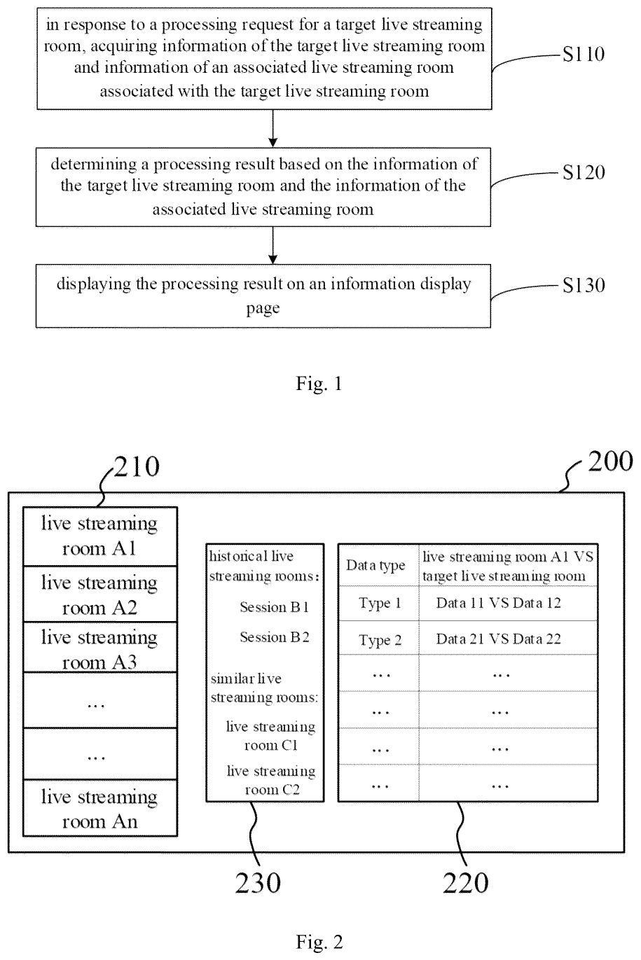

FIG. 1 is a flow schematic diagram of a live streaming processing method provided by some embodiments of the present disclosure. As shown in FIG. 1, in at least one embodiment, the method includes the following steps S110 to S130.

S110: in response to a processing request for a target live streaming room, acquiring information of the target live streaming room and information of an associated live streaming room associated with the target live streaming room;

S120: determining a processing result based on the information of the target live streaming room and the information of the associated live streaming room; and

S130: displaying the processing result on an information display page.

FIG. 2 is a schematic diagram of an information display page 200 provided by some embodiments of the present disclosure. As shown in FIG. 2, the information display page 200 may include a list region 210, and the list region 210 may be configured to display names of a plurality of to-be-processed live streaming rooms (e.g., a live streaming room A1, a live streaming room A2, . . . , a live streaming room An). In some embodiments, a name of a live streaming room for example may be a name of an associated object of the live streaming room, the associated object for example is a streamer of the live streaming room or an identifier of the live streaming room, e.g., a head portrait identifier of the streamer. The list for example is a follow list, and then each to-be-processed live streaming room is a live streaming room that the user follows. The associated live streaming room may be a live streaming room with an association relationship with the target live streaming room, e.g., a live streaming room with the same or similar streamer, a live streaming room with the same broadcast start time or the same type of live streaming room, etc.

For example, in the step S110, in case that a to-be-processed live streaming room in the list is selected, the selected to-be-processed live streaming room may be treated as the target live streaming room. A to-be-processed live streaming room in the list may be selected by interacting operations such as touch, voice, gestures, etc.

In some examples, the information display page may also be provided with a first control (which is not shown in the drawing), and the processing request for the target live streaming room for example may be generated in response to triggering the first control. For example, the live streaming room A1 is the currently selected live streaming room, and when the first control is triggered, a processing request for the live streaming room A1 may be generated.

In some other examples, the processing request for the target live streaming room may also be generated in other modes, and for example, the processing request for the target live streaming room may be generated in response to performing a first preset operation (e.g., operation of double-click, dragging, etc.) on the target live streaming room; or the processing request for the target live streaming room may be generated by a voice command; or the processing request for the target live streaming room may be generated by a gesture command, etc. The present disclosure does not make any limit to the generation mode of the processing request.

For example, after the processing request for the live streaming room A1 is received, information of the live streaming room A1 and information of at least one associated live streaming room associated with the live streaming room A1 are acquired, and there may be one or more associated live streaming rooms. In some embodiments below, illustration is carried out by adopting one associated live streaming room, but the present disclosure is not limited thereto. In the application process, information of a plurality of associated live streaming rooms may be acquired as required, and the subsequent steps may be performed based on the target live streaming room and the plurality of associated live streaming rooms.

For example, the information of the target live streaming room and the information of the associated live streaming room may both include viewing data, interaction data, resource exchange data, etc. The viewing data for example may include the number of viewers (e.g., real-time number of viewers, average number of viewers, and maximum number of viewers), viewing duration (e.g., viewing duration per viewer), etc. The interaction data for example may include comment data, etc. The resource exchange data for example may include a trading volume, etc.

For example, in the step S120, the processing result may include a data comparison result between the target live streaming room and the associated live streaming room, and the data comparison result includes a comparison result for at least one type of date among the viewing data, the interaction data, and the resource exchange data.

For example, in the step S130, as shown in FIG. 2, the information display page 200 may include a first result display region 220, and the first result display region 220 may be configured to display the data comparison result between the target live streaming room and the associated live streaming room. For example, in the case that the data comparison result includes various types of data, corresponding data of the target live streaming room and the associated live streaming room may be respectively compared for each data type. For example, a type I for example may be the real-time number of viewers, then data 11 may be the real-time number of viewers of the live streaming room A1 at the current moment, and data 12 may be the real-time number of viewers of the associated live streaming room at the current moment. A type II for example may be the average number of viewers, then data 21 may be the average number of viewers of the live streaming room A1 in the time period from a certain historical broadcast moment (e.g., a broadcast start moment) to the current moment, and data 22 may be the average number of viewers in a corresponding time period. For example, the data comparison result may also include information such as a data rising amplitude or a data falling amplitude of the target live streaming room relative to the associated live streaming room.

For example, the information display page may further include other regions besides the list region 210 and the first result display region 220, the embodiments of the present disclosure do not make any limit to a position relationship of the regions, and in the application process, the position relationship between the regions may be set according to actual demand. In addition, the regions included in the information display page may also be displayed in different layers, and for example, the list region 210 may be displayed in a first layer, and the first result display region 220 may be displayed in a floating layer above the first layer.

According to the live streaming processing method provided by the embodiments of the present disclosure, the information of the target live streaming room is processed, such as comparison processing, by combining the information of the associated live streaming room associated with the target live streaming room, so that related personnel can accurately know the situation of the live streaming room without frequently switching to other live streaming rooms to perform data comparison, thereby saving time, simplifying the operation, and improving the user experience.

For example, in some examples, the information of the associated live streaming room in the step S110 may be acquired by the following mode: in response to triggering a comparing operation with a historical live streaming room, acquiring information of the historical live streaming room and using the information of the historical live streaming room as the information of the associated live streaming room. For example, the historical live streaming room is a live streaming room initiated by an associated object of the target live streaming room before initiating the target live streaming room.

For example, the historical live streaming room and the target live streaming room may be different sessions of live streaming rooms initiated by the same associated object (e.g., the same streamer), and the broadcast time of the historical live streaming room is earlier than that of the target live streaming room.

For example, as shown in FIG. 2, a candidate region 230 may also be displayed on the information display page, and for example, the candidate region 230 may be displayed in response to triggering the processing request for the target live streaming room. At least one candidate live streaming room may be displayed in the candidate region 230. For example, a plurality of historical live streaming rooms of the target live streaming room may be displayed, such as a historical live streaming room with the session B1 and a historical live streaming room with the session B2, and B1 and B2 for example may be dates. When a certain historical live streaming room in the candidate region 230 is selected, a comparing operation on the target live streaming room and the selected historical live streaming room may be triggered, the selected historical live streaming room is treated as the associated live streaming room, and the information of the historical live streaming room may be treated as the information of the associated live streaming room.

For example, in some other examples, the information of the associated live streaming room in the step S110 may be acquired by the following mode: in response to triggering a comparing operation with a similar live streaming room, acquiring information of the similar live streaming room and using the information of the similar live streaming room as the information of the associated live streaming room.

For example, acquiring the information of the similar live streaming room may include: acquiring associated information of the target live streaming room, the associated information including a type of live streaming room; and determining the similar live streaming room of the target live streaming room and acquiring the information of the similar live streaming room based on the associated information.

For example, the type of live streaming room may includes a type of the associated object and/or a type of a live streaming content, the type of the associated object for example may include a full-category streamer, a food streamer, a clothing streamer, etc., and the type of the live streaming content may include a type of an article involved in the live streaming process, e.g., categories such as foods, clothing, furniture, etc. For example, a live streaming room with the same or similar live streaming room type with the target live streaming room may be searched as the similar live streaming room of the target live streaming room. In addition, the associated information may also include a current viewer quantity of the live streaming room, and for example, a live streaming room of which a current viewer quantity is at the same quantity range with a current viewer quantity of the target live streaming room is determined as the similar live streaming room.

For example, as shown in FIG. 2, a plurality of similar live streaming rooms (e.g., live streaming rooms C1 and C2) may also be displayed in the candidate region 230, and when a similar live streaming room in the candidate region 230 is selected, the comparing operation between the target live streaming room and the selected similar live streaming room may be triggered, the selected similar live streaming room is treated as the associated live streaming room, and the information of the similar live streaming room may be treated as the information of the associated live streaming room. By carrying out lateral comparison between the target live streaming room and the similar live streaming room, the advantages and disadvantages of the target live streaming room relative to the similar live streaming room can be seen, and the target live streaming room can be helped to timely make corresponding adjustment so as to achieve a better live streaming effect.

For example, the live streaming processing method may further include: in response to receiving an interacting operation on the candidate region 230, switching the candidate region 230 from displaying a first set of candidate live streaming rooms to displaying a second set of candidate live streaming rooms that are different from the first set of candidate live streaming rooms. The first set of candidate live streaming rooms and the second set of candidate live streaming rooms each include at least one candidate live streaming room, and the candidate live streaming room is the historical live streaming room of the target live streaming room or the similar live streaming room of the target live streaming room. Based on such mode, more candidate live streaming rooms can be provided as reference, which promotes the user experience.

For example, in some examples, the interacting operation may include a sliding operation, and when a left-and-right sliding operation is performed on the candidate region 230, the candidate region 230 may be switched to display other candidate live streaming rooms different from the currently displayed candidate live streaming rooms and for example, switched to display other historical live streaming rooms except for the sessions B1 and B2 and/or display other similar live streaming rooms except for the live streaming rooms C1 and C2.

For example, in some other examples, a second control (which is not shown in the drawing) may be displayed on the candidate region 320, and when the second control is triggered, the candidate region 230 may be switched to display other candidate live streaming rooms different from the currently displayed candidate live streaming room.

For example, the live streaming processing method may further include: in response to receiving an analysis request for the target live streaming room, acquiring an analysis result of the target live streaming room and displaying the analysis result on the information display page.

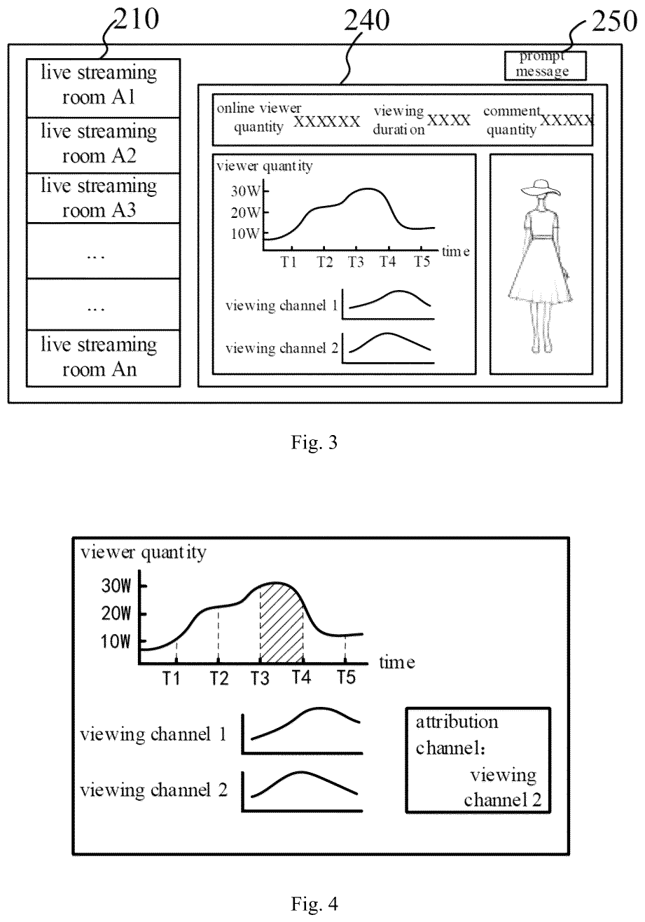

FIG. 3 is a schematic diagram of another information display page provided by some embodiments of the present disclosure. As shown in FIG. 3, the information display page may include a second result display region 240, and the second result display region 240 is configured to display the analysis result of the target live streaming room. For example, the analysis result may be obtained based on data of the target live streaming room in a time period from a historical broadcast moment to a current broadcast moment, and the historical broadcast moment is later than a start moment of the target live streaming room. For example, information, such as the online number of viewers, the viewing duration, the number of comments, etc., may be displayed in the second result display region 240. In addition, contents, such as a curve chart of the number of viewers along with time, a live streaming image, etc., may also be displayed.

For example, in some examples, the information display page may also be provided with a third control (which is not shown in the drawing), and the analysis request for the target live streaming room for example may be generated in response to triggering the third control. For example, the live streaming room A1 is a currently selected live streaming room, and when the third control is triggered, the analysis request for the live streaming room A1 may be correspondingly generated.

In some other examples, the analysis request for the target live streaming room may also be generated in other modes; for example, the analysis request is generated in response to performing a second preset operation (e.g., operation of single-click, etc.) different from the first preset operation on the target live streaming room; or the analysis request for the target live streaming room is generated by the voice command or the gesture command, and the like. The present disclosure does not make any limit to the triggering mode for the analysis request.

For example, the live streaming processing method may further include: in response to receiving a checking request for a viewing channel of the target live streaming room, displaying viewing channel information of the target live streaming room on the information display page.

FIG. 4 is a schematic diagram of a partial region of an information display page provided by some embodiments of the present disclosure. As shown in FIG. 4, for example, live streaming duration may be divided into a plurality of time periods (e.g., time periods 0-T1, T1-T2, T2-T3, etc.), a certain time period may be selected in an interacting form, and viewing channel analysis for the corresponding time period is triggered.

For example, in some examples, the viewing channel information may include: viewer quantity fluctuation information corresponding to a plurality of first-level viewing channels respectively. For example, a curve of the viewer quantity along with time of each first-level viewing channel, such as changing curves respectively corresponding to a viewing channel 1 and a viewing channel 2 as shown in the drawing, may be displayed in the second result display region 240. For example, the first-level viewing channels may include channels of recommendation, attention, short videos, etc.

For example, in some other examples, the viewing channel information may also include: a first-level attribution channel selected from the plurality of first-level viewing channels that causes fluctuation in the online viewer quantity of the target live streaming room, and the first-level attribution channel for example is a first-level viewing channel with the maximum viewer quantity fluctuation in the plurality of first-level viewing channels.

For example, each first-level viewing channel includes a plurality of second-level viewing channels. The second-level viewing channel is a more refined viewing sub-channel under the first-level viewing channel, for example, a recommending channel may include various recommendation categories, e.g., clothing industry recommendation, selective recommendation, intra-city recommendation, etc., and each recommendation category may be used as a second-level viewing channel.

Wherein, the viewing channel information may further include: a second-level attribution channel selected from a plurality of second-level viewing channels included in the first-level attribution channel that causes fluctuation in the online viewer quantity of the target live streaming room. For example, the second-level attribution channel is a second-level viewing channel with the maximum viewer quantity fluctuation in the plurality of second-level viewing channels included in the first-level attribution channel. That is, a second-level viewing channel with the maximum viewer quantity fluctuation in the corresponding time period may be determined as the second-level attribution channel from the plurality of second-level viewing channels under the first-level attribution channel.

For example, the live streaming processing method may further include: displaying viewing channel information of the target live streaming room in a corresponding time period on the information display page every predetermined period of time.

For example, the live streaming processing method may further include: in response to receiving a switching operation for different live streaming rooms in the list region 210, switching to display analysis results for different live streaming rooms in the second result display region 240. For example, as shown in FIG. 3, at the current moment, the live streaming room A1 is the target live streaming room, an analysis result for the live streaming room A1 is displayed in the second result display region 240. In a case where the target live streaming room is changed into a live streaming room A5 at a certain subsequent moment, it is switched to display an analysis result for the live streaming room A5 in the second result display region 240.

For example, the live streaming processing method may further include: displaying at least one prompt message on the information display page, each prompt message including a prompted live streaming room and a prompt event triggered by the prompted live streaming room, the prompted live streaming room is a to-be-processed live streaming room in a plurality of to-be-processed live streaming rooms that triggers the prompt event, and the target live streaming room is a live streaming room selected from the plurality of to-be-processed live streaming rooms. For example, the plurality of to-be-processed live streaming rooms are all live streaming rooms (live streaming rooms A1-An) displayed in the list region.

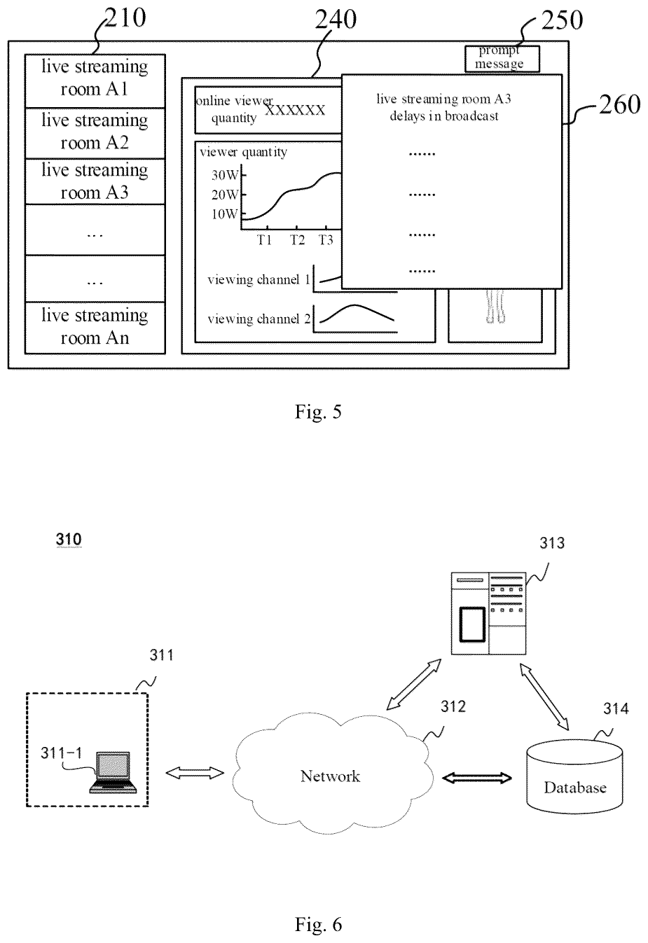

FIG. 5 is a schematic diagram of another information display page provided by some embodiments of the present disclosure. As shown in FIG. 3 and FIG. 5, the information display page may further include a fourth control (e.g., a control 250 marked as “prompt message”). In response to triggering the fourth control, a prompt region 260 may be displayed, and the prompt region 260 may be used for displaying at least one prompt message. For example, in the case that a certain to-be-processed live streaming room triggers the prompt event, the to-be-processed live streaming room may be used as a prompted live streaming room, and a prompt message is formed based on the name of the prompted live streaming room and the prompt event triggered by the prompted live streaming room, and the prompt message is displayed in the prompt region 260.

For example, in some examples, broadcasting time data of each to-be-processed live streaming room may be acquired, and the broadcast time data may include estimated broadcast start time, actual broadcast start time, estimated broadcast stop time, actual broadcast stop time, etc. For example, the prompt event may include at least one of the following events: the broadcast time data represents broadcast time delay of the to-be-processed live streaming room; or the broadcast time data represents abnormal termination of the to-be-processed live streaming room in the broadcasting process.

Each information involved in the present disclosure is obtained in case that all parties associated with each information are sufficiently authorized.

It should be noted that according to the embodiment of the present disclosure, an execution order of the respective steps of the live streaming processing method will not be limited; although the execution process of the respective steps is described in a specific order above, this does not constitute a limitation on the embodiments of the present disclosure. The respective steps in the live streaming processing method may be executed in serial or in parallel, which may be determined according to actual needs. For example, the live streaming processing method may further include more or fewer steps, for example, adding some pre-processing steps, or storing data of some intermediate procedures for use in subsequent processing and calculation to omit some similar steps.

FIG. 6 is a system that may be used to implement the live streaming processing method provided by the embodiments of the present disclosure. As shown in FIG. 6, the system 310 may include a terminal device 311, a network 312, a server 313, and a database 314. For example, the system 310 may be configured to implement the live streaming processing method provided by any embodiment of the present disclosure.

The terminal device 311 includes, for example, a computer 311-1. It may be understood that the terminal device 311 may be any other type of electronic device capable of performing data processing, including but not limited to, a desktop computer, a laptop, a tablet computer, a workstation, etc. The terminal device 311 may also be any device provided with an electronic device. Hardware configuration or software configuration of the terminal device will not be limited in the embodiments of the present disclosure. The terminal device 311 may execute the live streaming processing method provided in the embodiments of the present disclosure by running code.

The network 312 may be a single network, or a combination of at least two different networks. For example, the network 312 may include, but is not limited to, one or a combination of several of a local area network, a wide area network, a public network, a private network, etc.

The server 313 may be a separate server or a server group; and the respective servers within the group are connected through a wired or wireless network. A server group may be centralized, for example, a data center, or distributed. The server 313 may be local or remote.

The database 314 may broadly refer to a device having a storage function. The database 314 may be local or remote. The database 314 may include various types of memory, for example, Random Access Memory (RAM), Read Only Memory (ROM), and so on. The storage devices as mentioned above are just a few examples, and the storage device that the system 310 may use are not limited thereto.

The database 314 may be in interconnection or communication with the server 313 or a portion of the server 313 through the network 312, or in direct interconnection or communication with the server 313; or a combination of the above two modes may be adopted.

In some examples, the database 314 may be a standalone device. In other examples, the database 314 may also be integrated into at least one of the terminal device 311 and the server 313. For example, the database 314 may be set on the terminal device 311 or the server 313. For another example, the database 314 may also be distributed, with one portion set on the terminal device 311 and the other portion set on the server 313.

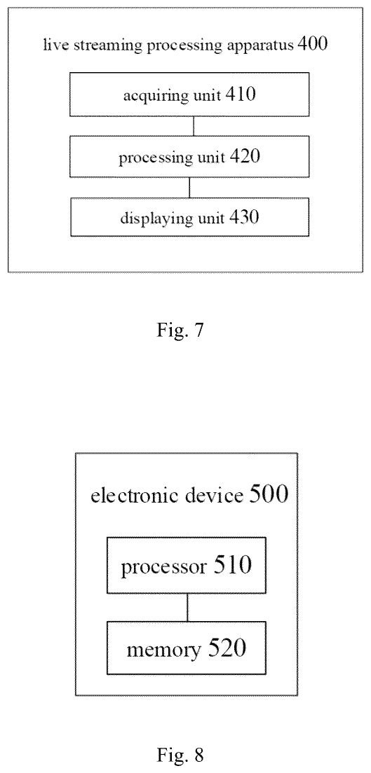

FIG. 7 is a schematic block diagram of a live streaming processing apparatus provided by some embodiments of the present disclosure. As shown in FIG. 7, the live streaming processing apparatus 400 includes an acquiring unit 410, a processing unit 420, and a displaying unit 430. For example, the live streaming processing apparatus 400 may be applied in a terminal device, or may be applied in any device or system which needs to process a live streaming room, and the embodiments of the present disclosure do not make any limit to it.

The acquiring unit 410 is configured to, in response to a processing request for a target live streaming room, acquire information of the target live streaming room and information of an associated live streaming room associated with the target live streaming room. For example, the acquiring unit 410 may perform the step S110 in the live streaming processing method as shown in FIG. 1.

The processing unit 420 is configured to determine a processing result based on the information of the target live streaming room and the information of the associated live streaming room. For example, the processing unit 420 may perform the step S120 in the live streaming processing method as shown in FIG. 1.

The displaying unit 430 is configured to display the processing result on an information display page. For example, the displaying unit 430 may perform the step S130 in the live streaming processing method as shown in FIG. 1.

For example, the acquiring unit 410, the processing unit 420, and the displaying unit 430 may be hardware, software, firmware, and any feasible combination thereof. For example, the acquiring unit 410, the processing unit 420, and the displaying unit 430 may be special-purpose or general-purpose circuits, chips or apparatuses, etc., or may be a combination of a processor and a memory. Specific implementation forms of the acquiring unit 410, the processing unit 420, and the displaying unit 430 will not be limited in the embodiments of the present disclosure.

It should be noted that in the embodiments of the present disclosure, each unit of the live streaming processing apparatus 400 corresponds to each step of the aforementioned live streaming processing method, and specific functions of the live streaming processing apparatus 400 may refer to related description on the live streaming processing method in the above and will not be repeated herein. The components and the structure of the live streaming processing apparatus 400 as shown in FIG. 7 are merely exemplary, but not limitative, and as required, the live streaming processing apparatus 400 may also include other components and structures. For example, in some examples, the live streaming processing apparatus 400 may further include a channel unit, and the channel unit may be configured to, in response to receiving a checking request for a viewing channel of the target live streaming room, display viewing channel information of the target live streaming room on the information display page; and/or display viewing channel information of the target live streaming room in a corresponding time period on the information display page every predetermined period of time.

FIG. 8 is a schematic block diagram of an electronic device provided by some embodiments of the present disclosure. As shown in FIG. 8, the electronic device 500 includes a processor 510 and a memory 520. The memory 520 is configured to store non-temporary computer readable instructions (e.g., one or more computer program modules). The processor 510 is configured to run the non-temporary computer readable instructions; and the non-temporary computer readable instructions, when run by the processor 510, may execute one or more steps in the live streaming processing method as described above. The memory 520 and the processor 510 may be interconnected through a bus system and/or other forms of connection mechanisms (not shown).

For example, the processor 510 may be a Central Processing Unit (CPU), a Digital Signal Processor (DSP), or other form of processing unit having a data processing capability and/or a program execution capability, for example, a Field Programmable Gate Array (FPGA), etc.; for example, the Central Processing Unit (CPU) may be an X86, or ARM architecture, etc. The processor 510 may be a general-purpose processor or a special-purpose processor, and may control other components in the electronic device 500 to execute desired functions.

For example, the memory 520 may include any combination of one or more computer program products; and the computer program products may include various forms of computer readable storage media, for example, a volatile memory and/or a non-volatile memory. The volatile memory may include, for example, a Random Access Memory (RAM) and/or a cache, or the like. The non-volatile memory may include, for example, a Read Only Memory (ROM), a hard disk, an Erasable Programmable Read Only Memory (EPROM), a portable Compact Disk Read Only Memory (CD-ROM), a USB memory, a flash memory, or the like. One or more computer program modules may be stored on the computer readable storage medium, and the processor 510 may run the one or more computer program modules, to implement various functions of the electronic device 500. Various applications and various data, as well as various data used and/or generated by the applications may also be stored on the computer readable storage medium.

It should be noted that in the embodiments of the present disclosure, the above description of the live streaming processing method may be referred to for specific functions and technical effects of the electronic device 500, and no details will be repeated here.

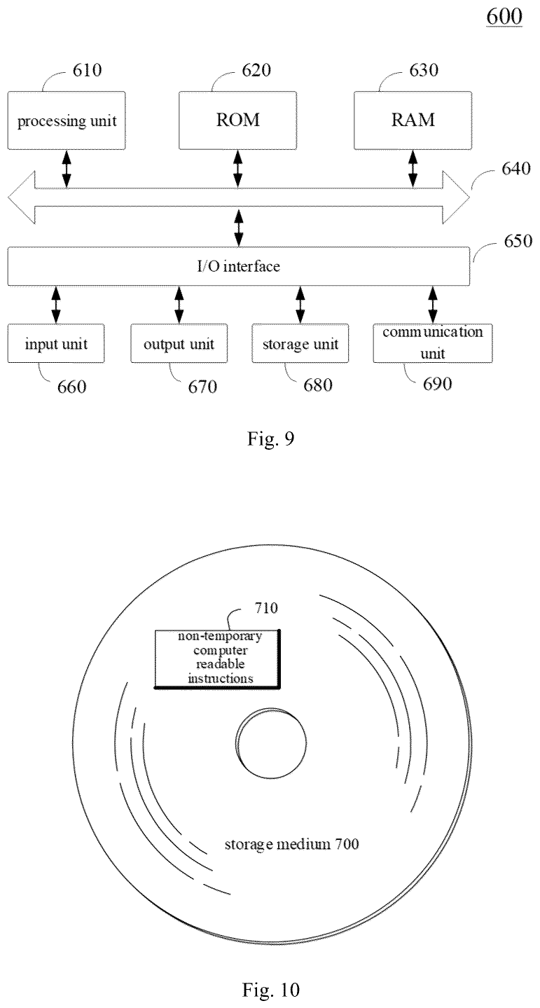

FIG. 9 is a schematic block diagram of another electronic device provided by some embodiments of the present disclosure. The electronic device 600, for example, is suitable for implementing the live streaming processing method provided by the embodiment of the present disclosure. The electronic device 600 may be a terminal device, or the like. It should be noted that the electronic device 600 shown in FIG. 9 is only an example and does not impose any limitations on the functionality and scope of use of the embodiments of the present disclosure.

As shown in FIG. 9, the electronic device 600 may include the processing unit (e.g., a central processing unit (CPU), a graphics processing unit (GPU)) 610, which may execute various appropriate actions and processing according to programs stored in the ROM 620 or programs loaded to the RAM 630 from the storage unit 680. A plurality of programs and data required for the operation of the electronic device 600 are also stored in the RAM 630. The processing unit 610, the ROM 620 and the RAM 630 are connected with each other through a bus 640. An input/output (I/O) interface 650 is also connected to the bus 640.

In general, the following units may be connected to the I/O interface 650: an input unit 660 including a touch screen, a touch pad, a keyboard, a mouse, a camera, a microphone, an accelerometer, a gyroscope and the like; an output unit 670 including a liquid crystal display (LCD), a loudspeaker, a vibrator and the like; a storage unit 680 including magnetic tapes and hard disks; and a communication unit 690. The communication unit 690 may allow the electronic device 600 to communicate wirelessly in a wired manner with other electronic devices to exchange data. Although FIG. 9 shows the electronic device 600 including a plurality of units, it should be understood that not all the shown units are required to be implemented or included. The electronic device 600 may alternatively implement or include more or less units.

For example, according to the embodiments of the present disclosure, the live streaming processing method shown in FIG. 1 may be implemented as computer software programs. For instance, the embodiment of the present disclosure provides a computer program product, which includes computer programs hosted on a non-transient computer readable medium. The computer programs contain program codes for executing the above live streaming processing method, in such an embodiment, the computer programs may be unloaded and installed from the internet through the communication unit 690, or installed from the storage unit 680, or installed from the ROM 620. The functions defined in the live streaming processing method provided by the embodiment of the present disclosure are executed when the computer programs are executed by the processing unit 610.

At least one embodiment of the present disclosure provides a storage medium, configured to store non-temporary computer readable instructions, the non-temporary computer readable instructions, when executed by a computer, implement the live streaming processing method according to any embodiment of the present disclosure.

FIG. 10 is a schematic diagram of a storage medium provided by some embodiments of the present disclosure. As shown in FIG. 10, the storage medium 700 is configured to store non-temporary computer readable instructions 710. For example, the non-temporary computer readable instructions 710, when executed by a computer, implement one or more steps of the live streaming processing method according to the foregoing.

For example, the storage medium 700 may be applied in the electronic device 500 described above. For example, the storage medium 700 may be the memory 520 in the electronic device 500 shown in FIG. 8. For example, a related description of the storage medium 700 may be referred to the corresponding description of the memory 520 in the electronic device 500 shown in FIG. 8 and will not be repeated herein.

In the foregoing, a live streaming processing method, a live streaming processing apparatus, an electronic device, a storage medium, and a program product provided by embodiments of the present disclosure are described with reference to FIGS. 1 to 10. According to the live streaming processing method provided by embodiments of the present disclosure, the information of the target live streaming room is processed, such as comparison processing, by combining the information of the associated live streaming room associated with the target live streaming room, so that related personnel can accurately know the situation of the live streaming room without frequently switching to other live streaming rooms to carry out data comparison, thereby saving time, simplifying the operation, and improving the user experience.

It should be noted that the above storage medium (computer readable medium) of the present disclosure may be a computer readable signal medium, a non-transitory computer readable storage medium, or any combination of the above. The non-transitory computer readable storage medium, for instance, may be, but not limited to, electrical, magnetic, optical, electromagnetic, infrared, or semiconductor system, device, or equipment, or a combination of the above. A more specific example of the non-transitory computer readable storage medium may include but not limited to: electrical connection having one or more wires, portable computer disk, hard disk, RAM, ROM, erasable programmable read-only memory (EPROM), flash memory, optical fiber, portable compact disk read-only memory (CD-ROM), optical storage unit, magnetic storage unit, or any suitable combination of the above. In the present disclosure, the non-transitory computer readable storage medium may be any tangible medium containing or storing programs. The programs may be used by a command execution system, device or unit or used in combination with the command execution system, device or unit. However, in the present disclosure, the computer readable signal medium may include data signals propagated in baseband or as part of carrier, in which computer readable program codes are hosted. The propagated data signals may adopt a plurality of forms, including but not limited to electromagnetic signals, optical signals or any suitable combination of the above. The computer readable signal medium may also be any computer readable medium except the non-transitory computer readable storage medium. The computer readable signal medium can send, propagate or transmit programs used by the command execution system, device or unit or used in combination with the command execution system, device or unit. The program codes contained in the computer readable medium can be transmitted by any appropriate medium, including but not limited to: wire, optical cable, radio frequency (RF) and the like, or any suitable combination of the above.

In some embodiments, the client and the server may communicate by utilization of any network protocol which is currently known or developed in the future such as Hyper Text Transfer Protocol (HTTP), and may be interconnected with digital data communication (e.g., communication network) in any form or medium. The example of the communication network includes local area network (LAN), wide area network (WAN), internet, end-to-end network (e.g., ad hoc end-to-end network), and any network which is current known or developed in the future.

The above computer readable medium may be contained in the above electronic device and may also exist alone and not be assembled into the electronic device.

The above computer readable medium hosts one or more programs. When the above one or more programs are executed by the electronic device, the electronic device is configured to: in response to a processing request for a target live streaming room, acquire information of the target live streaming room and information of an associated live streaming room associated with the target live streaming room; determine a processing result based on the information of the target live streaming room and the information of the associated live streaming room; and display the processing result on an information display page.

Alternatively, the above computer readable medium hosts one or more programs. When the above one or more programs are executed by the electronic device, the electronic device is configured to: in response to a processing request for a target live streaming room, acquire information of the target live streaming room and information of an associated live streaming room associated with the target live streaming room; determine a processing result based on the information of the target live streaming room and the information of the associated live streaming room; and display the processing result on an information display page.

Computer program codes for performing the operations of the present disclosure may be written in one or more programming languages or a combination thereof. The above programming languages include but not limited to object-oriented programming languages such as Java, Smalltalk and C++, and also include conventional procedural programming languages such as “C” language or similar programming languages. The program codes may be completely executed on a user computer, partially executed on the user computer, executed as a separate package, partially executed on the user computer and partially executed on a remote computer, or completely executed on the remote computer or the server. In the case where the remote computer is involved, the remote computer may be connected to the user computer through any kind of network, such as a Local Area Network (LAN) or a Wide Area Network (WAN), or, alternatively, may be connected to an external computer (for instance, connected via the Internet by utilization of Internet service providers).

The flowcharts and the block diagrams in the drawings show possible architectures, functions and operations of the system, the method and the computer program product according to the embodiments of the present disclosure. In this regard, each block in the flowchart or the block diagram may represent a module, a program segment, or a part of code. The module, the program segment, or the part of the code contains one or more executable instructions for implementing specified logic functions. It should be also noted that in some alternative implementations, the functions marked in the blocks may also occur in a different order from those marked in the drawings. For instance, two consecutive blocks may actually be executed basically in parallel, and sometimes, may also be executed in a reverse order, determined by involved functions. It should be also noted that each block in the block diagram and/or the flowchart and the combination of the blocks in the block diagram and/or the flowchart may be implemented by a dedicated hardware-based system that performs a specified function or operation, and may also be implemented by the combination of a special hardware and computer instructions.

Units involved in the embodiments of the present disclosure may be implemented by software, and may also be implemented by hardware. Wherein, the name of the unit should not define the unit under certain circumstances.

The functions described above in this document may be at least partially executed by one or more hardware logical units. For instance, without limitation, demonstration type hardware logical units that may be used include: field programmable gate array (FPGA), application-specific integrated circuit (ASIC), application specific standard parts (ASSP), system on a chip (SOC), complex programmable logic device (CPLD), etc.

In the present disclosure, the machine readable medium may be a tangible medium and may include or store programs used by command execution system, device or equipment or used in combination with the command execution system, device or equipment. The machine readable medium may be a machine readable signal medium or a machine readable storage medium. The machine readable medium may include but not limited to electronic, magnetic, optical, electromagnetic, infrared, or semiconductor system, device or equipment, or any suitable combination of the above. A more specific example of the machine readable storage medium may include electrical connection based on one or more wires, portable computer disk, hard disk, RAM, ROM, EPROM, flash memory, optical fiber, CD-ROM, optical storage unit, magnetic storage unit, or any suitable combination of the above.

The above description is only the explanation of a partial embodiment of the present disclosure and the used technical principle. It should be understood by those skilled in the art that the disclosure scope involved in the disclosure is not limited to the technical solution formed by the specific combination of the above technical features, but also covers other technical solutions formed by any combination of the above technical features or their equivalent features without departing from the above disclosed concept. For example, the technical solution formed by replacing the above features with (but not limited to) technical features with similar functions disclosed in the disclosure.

In addition, although the operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in a plurality of embodiments alone or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of realizing the claims.

1. A live streaming processing method, comprising:
in response to a processing request for a target live streaming room, acquiring information of the target live streaming room and information of an associated live streaming room associated with the target live streaming room;
determining a processing result based on the information of the target live streaming room and the information of the associated live streaming room; and
displaying the processing result on an information display page.

2. The method according to claim 1, wherein the processing result comprises a data comparison result between the target live streaming room and the associated live streaming room, and the data comparison result comprises a comparison result of at least one type of data among viewing data, interaction data, and resource exchange data.

3. The method according to claim 1, wherein acquiring the information of the target live streaming room and the information of the associated live streaming room associated with the target live streaming room comprises:
in response to triggering a comparing operation with a historical live streaming room, acquiring information of the historical live streaming room and using the information of the historical live streaming room as the information of the associated live streaming room,
wherein the historical live streaming room is a live streaming room initiated by an associated object of the target live streaming room before initiating the target live streaming room.

4. The method according to claim 1, wherein acquiring the information of the target live streaming room and the information of the associated live streaming room associated with the target live streaming room comprises:
in response to triggering a comparing operation with a similar live streaming room, acquiring information of the similar live streaming room and using the information of the similar live streaming room as the information of the associated live streaming room.

5. The method according to claim 4, wherein acquiring the information of the similar live streaming room comprises:
acquiring associated information of the target live streaming room, wherein the associated information comprises a type of live streaming room; and
determining the similar live streaming room of the target live streaming room and acquiring the information of the similar live streaming room based on the associated information.

6. The method according to claim 1, wherein the information display page comprises a candidate region;
the live streaming processing method further comprising: in response to receiving an interacting operation on the candidate region, switching the candidate region from displaying a first set of candidate live streaming rooms to displaying a second set of candidate live streaming rooms that are different from the first set of candidate live streaming rooms,
wherein the first set of candidate live streaming rooms and the second set of candidate live streaming rooms each comprise at least one candidate live streaming room, and the candidate live streaming room is a historical live streaming room of the target live streaming room or a similar live streaming room of the target live streaming room.

7. The method according to claim 1, further comprising:
in response to receiving a checking request for a viewing channel of the target live streaming room, displaying viewing channel information of the target live streaming room on the information display page; and/or
displaying the viewing channel information of the target live streaming room in a corresponding time period on the information display page every predetermined period of time.

8. The method according to claim 7, wherein the viewing channel information comprises:
viewer quantity fluctuation information corresponding to a plurality of first-level viewing channels respectively, and/or
a first-level attribution channel selected from the plurality of first-level viewing channels that causes fluctuation in the online viewer quantity of the target live streaming room.

9. The method according to claim 8, wherein each of the plurality of first-level viewing channels comprises a plurality of second-level viewing channel;
wherein the viewing channel information further comprises: a second-level attribution channel selected from a plurality of second-level viewing channels comprised in the first-level attribution channel that causes fluctuation in the online viewer quantity of the target live streaming room.

10. The method according to claim 1, further comprising:
displaying at least one prompt message on the information display page, each of the at least one prompt message comprises a prompted live streaming room and a prompt event triggered by the prompted live streaming room,
wherein the prompted live streaming room is a to-be-processed live streaming room in a plurality of to-be-processed live streaming rooms that triggers the prompt event, and the target live streaming room is a live streaming room selected from the plurality of to-be-processed live streaming rooms.

11. The method according to claim 10, further comprising: acquiring play time data of the plurality of to-be-processed live streaming rooms;
wherein the prompt event comprises: the play time data representing play time delay.

12. The method according to claim 2, wherein acquiring the information of the target live streaming room and the information of the associated live streaming room associated with the target live streaming room comprises:
in response to triggering a comparing operation with a historical live streaming room, acquiring information of the historical live streaming room and using the information of the historical live streaming room as the information of the associated live streaming room,
wherein the historical live streaming room is a live streaming room initiated by an associated object of the target live streaming room before initiating the target live streaming room.

13. The method according to claim 2, wherein acquiring the information of the target live streaming room and the information of the associated live streaming room associated with the target live streaming room comprises:
in response to triggering a comparing operation with a similar live streaming room, acquiring information of the similar live streaming room and using the information of the similar live streaming room as the information of the associated live streaming room.

14. The method according to claim 2, wherein the information display page comprises a candidate region;
the live streaming processing method further comprising: in response to receiving an interacting operation on the candidate region, switching the candidate region from displaying a first set of candidate live streaming rooms to displaying a second set of candidate live streaming rooms that are different from the first set of candidate live streaming rooms,
wherein the first set of candidate live streaming rooms and the second set of candidate live streaming rooms each comprise at least one candidate live streaming room, and the candidate live streaming room is a historical live streaming room of the target live streaming room or a similar live streaming room of the target live streaming room.

15. The method according to claim 2, further comprising:
in response to receiving a checking request for a viewing channel of the target live streaming room, displaying viewing channel information of the target live streaming room on the information display page; and/or
displaying viewing channel information of the target live streaming room in a corresponding time period on the information display page every predetermined period of time.

16. The method according to claim 2, further comprising:
displaying at least one prompt message on the information display page, each of the at least one prompt message comprises a prompted live streaming room and a prompt event triggered by the prompted live streaming room,
wherein the prompted live streaming room is a to-be-processed live streaming room in a plurality of to-be-processed live streaming rooms that triggers the prompt event, and the target live streaming room is a live streaming room selected from the plurality of to-be-processed live streaming rooms.

17. An electronic device, comprising:
a processor;
a memory comprising one or more computer program modules,
wherein the one or more computer program modules are stored in the memory and configured to be executed by the processor, and the one or more computer program modules comprise instructions for implementing the live streaming processing method, wherein the live streaming processing method comprises:
in response to a processing request for a target live streaming room, acquiring information of the target live streaming room and information of an associated live streaming room associated with the target live streaming room;
determining a processing result based on the information of the target live streaming room and the information of the associated live streaming room; and
displaying the processing result on an information display page.

18. The electronic device according to claim 17, wherein the processing result comprises a data comparison result between the target live streaming room and the associated live streaming room, and the data comparison result comprises a comparison result of at least one type of data among viewing data, interaction data, and resource exchange data.

19. The electronic device according to claim 17, wherein acquiring the information of the target live streaming room and the information of the associated live streaming room associated with the target live streaming room comprises:
in response to triggering a comparing operation with a historical live streaming room, acquiring information of the historical live streaming room and using the information of the historical live streaming room as the information of the associated live streaming room,
wherein the historical live streaming room is a live streaming room initiated by an associated object of the target live streaming room before initiating the target live streaming room.

20. A computer-readable storage medium for storing non-transitory computer-readable instructions, the non-transitory computer-readable instructions, when executed by a computer, implement the live streaming processing method, wherein the live streaming processing method comprises:
in response to a processing request for a target live streaming room, acquiring information of the target live streaming room and information of an associated live streaming room associated with the target live streaming room;
determining a processing result based on the information of the target live streaming room and the information of the associated live streaming room; and
displaying the processing result on an information display page.
